(19) United States
(12) Patent Application Publication
(10) Pub. No.: US 2004/0138040 A1
(43) Pub. Date: Jul. 15, 2004

(54) Decanter centrifuge control

(76) Inventors: Gary L. Hensley, Kingwood, TX (US); Tom McDuffie, Houston, TX (US); Lee Hilpert, Livingston, TX (US)

Correspondence Address: Tim Cook, Browning Bushman P.C., Suite 1800, 5718 Westheimer, Houston, TX, 77057, US

(21) Appl. No.: 10/342,715

(22) Filed: Jan. 15, 2003

(51) Int. Cl. B04B 9/10

(52) U.S. Cl. 494/53; 494/84

(57) ABSTRACT

A hydrostatic backdrive to control conveyor or differential speed in a centrifuge is provided. In a first embodiment, a preselected differential speed is selected by an input to a pump/motor, i.e., a variable volume positive displacement pump. The variable volume pump provides hydraulic drive fluid to a backdrive motor, which drives the conveyor. If solids content of the influent to the centrifuge changes, this is sensed by the backdrive motor, which sends a feedback signal to the variable volume pump to raise or lower its output in response. This way, in the first embodiment, a constant differential speed is maintained. In a second embodiment, the drive on the conveyor is monitored to maintain a constant torque on the conveyor. If solids content of the influent changes, this is sensed by the torque monitor, which sends a signal to the variable volume pump to increase or decrease flow as necessary to maintain that selected torque on the conveyor. The backdrive motor and the variable volume pump are coupled together in a closed loop system to conserve the hydraulic energy of the operating fluid of the system.

### FIELD OF THE INVENTION

The present invention relates generally to the field of decanter centrifuges, and, more particularly, to a method and structure for controlling the speed differential between the bowl and the screw conveyor in a decanter centrifuge.

### BACKGROUND OF THE INVENTION

A decanter centrifuge is commonly used for separating solid matter from a solids-laden liquid. For example, drilling mud returns to the surface having picked up cuttings having a wide range of sizes of solids and these solids must be effectively separated from the drilling mud so that the drilling mud can be recycled. For another example, many manufacturing process use vast quantities of water and during such a manufacturing process, the water picks up solid waste matter which must be removed from the water before it can be discharged, whether it is into the environment or into storage. Decanter centrifuges have proved to be effective and efficient in carrying out this function of removing the solids from the recyclable liquid.

Generally, a decanter centrifuge comprises a cylindrical or frustoconical bowl rotating in one direction and at one speed, and a screw conveyor rotating in the same direction but at a differept speed. The difference in the speeds of the bowl and the screw conveyor is commonly known in the art as the differential speed.

The bowl spins at a high rate of speed, creating a force to cause the heavier solids in the fluid feed mixture to separate from the carrier fluid outward toward the inside surface of the bowl. The screw conveyor may be leading or lagging the bowl, i.e. spinning faster or slower than the bowl. The bowl conveys the solids toward a solids discharge port of the decanter centrifuge, while the purified liquid is discharged from the fluid discharge port.

Differential speed can be varied depending on a number of factors, including the quantity of solids entrained in the fluid feed mixture and the purity of the liquid discharge required for a specific application. If the quantity of solids were to remain a constant feed rate, then a constant speed for the bowl and the screw conveyor could be set and the decanter centrifuge could operate practically indefinitely at a steady state of operation. Unfortunately, the concentration of solids does not remain constant, but can vary fairly widely depending on the operation generating the fluid feed mixture. For example, drilling operations are not typically conducted in homogeneous geological structures, but rather through various types of foundations with more or less rock, sand, sandstone, shale, and other materials. As the drilling mud carries the cuttings from the drill bit, the material that has been removed by the drill bit thus changes over time, and the decanter centrifuge is subjected to changes in the type and quantity of material which must be removed from the mud.

If the quantity of solids entrained in the fluid feed mixture increases, then the amount of separated solid material which must be moved by the screw conveyor increases commensurately. If the amount of solids is excessive, then the screw conveyor can become clogged, or the drive mechanism which drives the decanter centrifuge can be over-torqued. Consequently, differential speed, that is, the speed differential between the bowl and the screw conveyor, must take into account just how much solid material is being removed at all times. If the differential speed is made too high, in order to avoid over-torquing of the decanter centrifuge, then the separation performance suffers. Conversely, the differential speed must be high enough to accommodate the solids being introduced in the fluid feed mixture. Further, a lower differential speed results in more fluid being removed from the solids to provide the driest solids discharge. That condition provides the most benefit from the centrifuging process.

A number of different drive systems for developing the differential speed between the bowl and the screw conveyor are known in the art. Such drive systems may be broadly classified as backdrive systems with electric motors and a differential gear, and hydraulic drive systems. Such typical systems are illustrated in U.S. Pat. No. 5,681,256 to Nagafuji. For both types of systems, control relies upon tachometers and torque sensors. In each of these systems, a compromise is made between the purity or clarity of the liquids discharge, system throughput, and reliability of the system for continuous operation. Thus, differential speed is maintained at a rate sufficient to provide assurance that the system will not become clogged, and therefore trip off on over-torque control. As a consequence, in this tradeoff, the solids discharge generally as more fluid remaining entrained therein than is ideal.

Thus there remains a need for a centrifugal control system which controls the differential speed at a specified speed so that the solids discharge has the least amount of fluid included with the solids, for a solids discharge that is as dry as possible. Alternatively, a system is needed which monitors the torque on the screw conveyor and maintains that torque so that the differential speed is maintained as low as possible without overloading the centrifuge. In either case, the automatic control of the differential speed should operate independent of the rotational speed of the bowl. The present invention is directed to that need in the art.

### SUMMARY OF THE INVENTION

The present invention provides a hydrostatic backdrive to control differential speed in a decanting centrifuge. In a first embodiment, a preselected differential speed is selected by an input to a pump/motor, i.e., a variable volume positive displacement pump. The variable volume pump provides hydraulic drive fluid to a backdrive motor, which drives the conveyor. If solids content of the influent to the centrifuge changes, this is sensed by the backdrive motor, which sends a feedback signal to the variable volume pump to raise or lower its output in response. This way, in the first embodiment, a constant differential speed is maintained.

In a second embodiment, the drive on the scroll conveyor is monitored to maintain a constant torque on the screw conveyor. If solids content of the influent changes, this is sensed by the torque monitor, which sends a signal to the variable volume pump to increase or decrease flow as necessary to maintain that selected torque on the screw conveyor.

Maintaining the differential speed based on torque permits setting the system to the lowest possible differential speed without damaging the system, particularly the gear reducer driving the screw conveyor. In this mode, the maximum benefit of the centrifuge is obtained by producing the driest possible solids output from the centrifuge.

The backdrive motor and the variable volume pump are coupled together in a closed loop system to conserve the hydraulic energy of the operating fluid of the system.

These and other features and advantages of this invention will be readily apparent to those skilled in the art from a review of the following detailed description along with the accompanying drawings.

### BRIEF DESCRIPTION OF THE DRAWINGS

So that the manner in which the above recited features, advantages and objects of the present invention are attained and can be understood in detail, more particular description of the invention, briefly summarized above, maybe had by reference to embodiments thereof which are illustrated in the appended drawings.

FIG. 1 is a simplified schematic diagram of the system of this invention.

FIG. 2 is a more detailed schematic diagram of the invention showing various control components.

FIG. 3 is an elevation view of the invention wherein the backdrive motor is mounted within the screw conveyor of the horizontal centrifuge

### DETAILED DESCRIPTION OF A PREFERRED EMBODIMENT

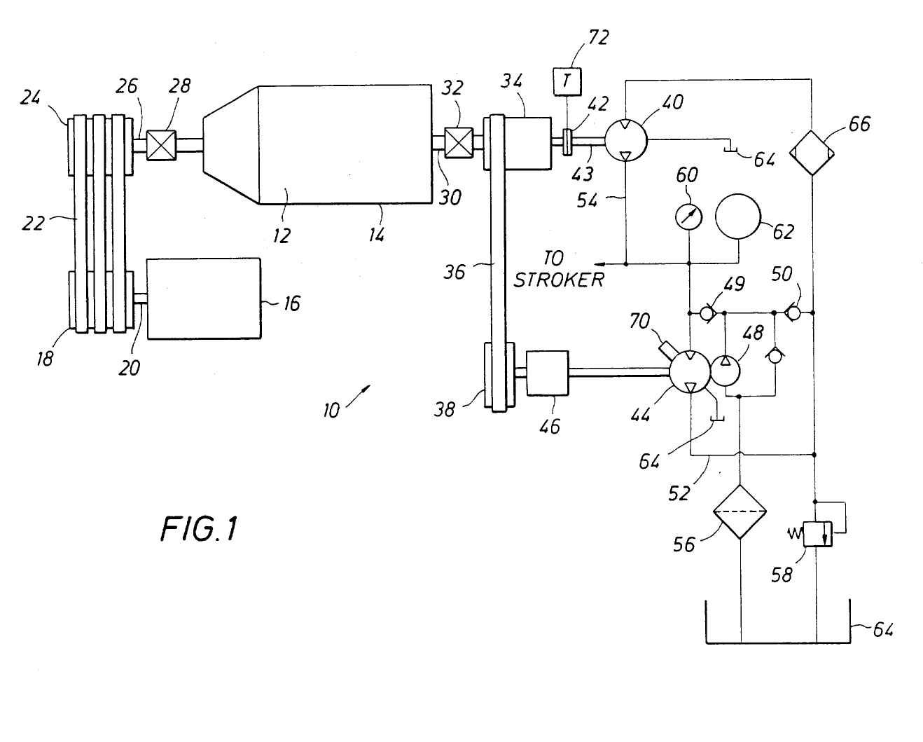

FIG. 1 depicts a simplified schematic diagram of a centrifuge control system 10 of the invention. The system 10 includes a known decanter centrifuge 12 which includes an outer bowl 14 and an internal screw-type conveyor (not shown) for the separation of solids from an influent liquid. The centrifuge 12 is driven by an electric motor 16 which is coupled to a drive pulley 18 by a shaft 20. The pulley 18 drives a plurality of V-belts 22 which are in turn coupled mechanically to a driven pulley 24. The driven pulley 24 is coupled to a co-axial shaft 26 which is supported by a bearing 28 and from there to the bowl 14. Thus, the bowl 14 turns at the same rate as the pulley 24 and the shaft 26.

The bowl 14 is in turn directly coupled to a shaft 30 which is supported on a bearing 32. The shaft 30 is in turn coupled to the outside casing of a gear box or gear reducer 34, which preferably provides a set gear reduction. Thus, the outer sheave of the gear box turns at bowl speed. The gear reducer 34 drives a plurality of V-belts 36 which in turn drive a driven pulley 38. The pulley 38 drives a metering pump/motor 44 through a bearing 46. The metering pump/motor 44 is a variable volume pump with rotating pistons with a reaction plate. Tilting the reaction plate varies the stroke and therefore the volume pumped by the positive displacement pump.

Driven off the same shaft as the pump/motor 44 is a charge pump 48, a constant volume, positive displacement pump. The charge pump simply provides hydraulic pressure to the various functions and servos throughout the hydraulic circuit and to maintain constant fluid flow throughout the system for cooling and flushing the system.

Check valves 49 and 50 discharge hydraulic fluid into one side of the circuit or the other to keep charge pressure in the low side of the loop. Flow from the pump 44 is bi-directional.

The pump/motor 44 controls the speed of the motor 40. The motor 40 is being driven by torque on the backdrive shaft and thus tries to act like a pump and drive the pump 44 as a motor. The variable volume of hydraulic fluid drives a back drive motor 40, which is coupled through a coupling 42 through the gear reducer 34 to drive the screw conveyor. Thus, the torque on the screw conveyor is coupled back to the back drive motor. In this way, for a lagging screw, if the solids content of the influent into the centrifuge increases, the torque also increases on the screw conveyor. Since the screw conveyor and the bowl turn in the same direction, increasing the speed of the screw conveyor by increasing the speed of the back drive motor 40 reduces the relative speed between the bowl and the screw conveyor. Reducing the relative speed of the screw conveyor increases torque on the conveyor but produces drier solids.

At this point, it should be noted that, in known gear box systems, the relation of increasing or decreasing conveyor speed and increasing or decreasing back drive motor speed depends on the relation of the selected differential speed and the fixed speed of the gear box. In the hydraulic drive system of the present invention, however, an increase in the back drive motor speed will always increase the conveyor speed. In another aspect of the invention, the back drive motor when acting as a pump functions as a true variable ratio transmission rather than a slip coupling.

The system is also provided with a fluid filter 56 and a fluid cooler 58 of conventional design. Also provided are a pressure indication 60 and a pressure switch 62 for monitoring and over pressure protection, respectively. Hydraulic fluid is provided from a sump or reservoir 64. Input to the back drive motor 40 is regulated by a servo valve 66. Finally, in a first embodiment, the pump/motor 44 is provided with a manual set 70 which sets the nominal stroke for the pump/motor, and therefore the nominal differential speed for the system. This differential speed is automatically maintained, regardless of the bowl speed. Alternatively, in a second embodiment, the system is provided with a torque sensor 72, shown diagrammatically as sensing the coupling 42, to maintain a constant torque on the system by varying conveyor speed. Once again, differential speed is maintained, regardless of torque.

During normal operation, with solids content remaining fairly constant, the manual set 70 determines the stroke of the pump/motor 44, which determines the flow rate from the pump/motor 44. This flow rate drives the back drive motor 40 at the preselected, nominal speed for a selected torque on the screw conveyor. If solids content of the influent increases, this is sensed as an increase in torque by increasing torque output from the back drive motor 40. Increasing torque output from the back drive motor increases the operating pressure on the discharge line 54 and directs the stroker of the pump/motor 44 to decrease flow from the pump/motor, thereby slowing the back drive motor 40 and increasing differential speed to take care of the increase in solids. A drop in solids in the influent works the other way around to decrease differential speed, thereby maintaining a preselected torque on the screw conveyor.

Assume for purposes of explanation that the bowl is turning at 4000 rpm and the back drive planetary gear reducer 34 has a 53:1 reduction ratio. The rpm of the conveyor, which is driven by the gear reducer, is 4000/53=75 rpm differential, which means that the bowl is turning at 4000 rpm, and the conveyor is turning at 3925 rpm. The gear reducer has the sun gear held stationary by the back drive shaft. If we allow the back drive shaft to turn in the same direction as the bowl, that has the same effect as changing the gearbox ratio. If we allow the back drive shaft to turn at 2000 rpm, then the new conveyor speed is now (4000−2000)/53=37.7 rpm differential. It follows from this that if we have a hydraulic motor driving the back drive shaft, the shaft can turn at any desired speed as long as the hydraulic pump is of sufficient size. Since the back drive shaft wants to turn in the same direction as the bowl, then in effect the motor becomes the pump and the pump becomes a metering motor that controls speed by controlling outlet flow of the back drive motor/pump. The energy from this operation is looped back into pump/motor driver in an operation referred to herein as “bootstrapping”. In summary, allowing the back drive shaft to turn in the same direction as the bowl causes the conveyor to slow down. Turning the back drive shaft in the opposite direction on the bowl causes the conveyor to speed up. Also note that turning in the opposite direction to the bowl requires energy into the back drive, so the pump acts as a pump and the motor acts as a motor, and the energy requirement still loops back to the prime mover.

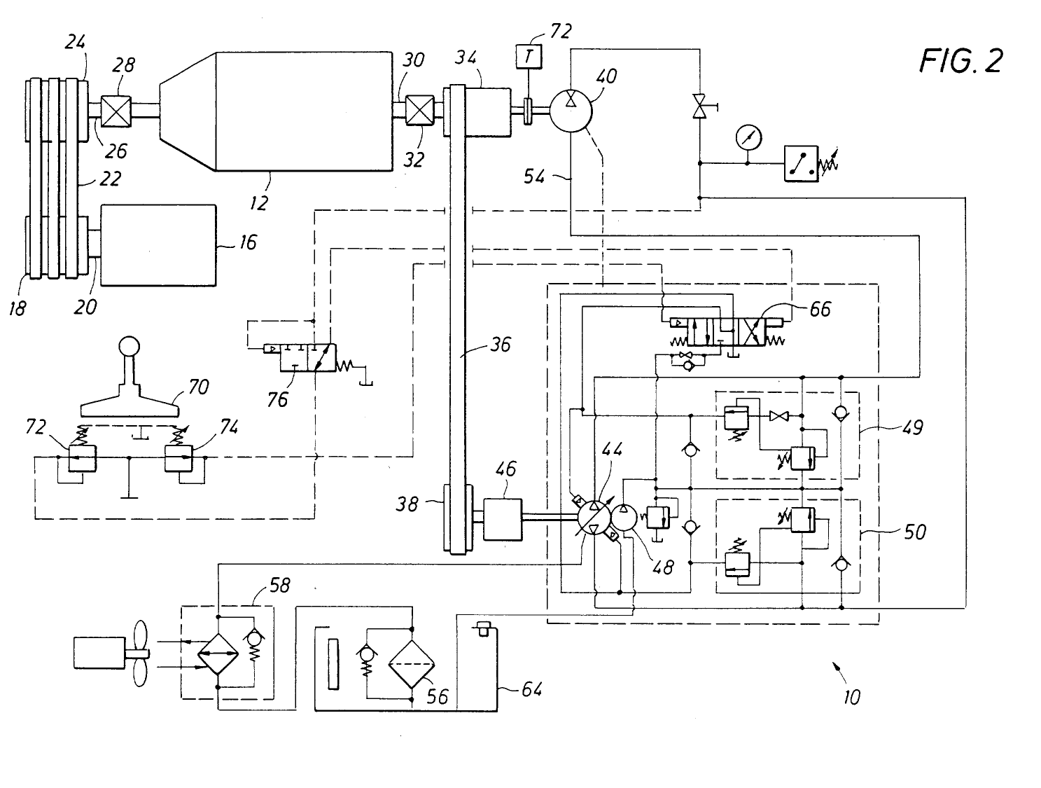

With reference to FIG. 1 and 2, both drives have a mechanical means of controlling pump flow so the conveyor speed can be preset to any desired level. The purpose of the torque sensing mechanism is to increase conveyor speed should the torque start to exceed the gear reducer's maximum allowable torque, and then to return the conveyor to its slower speed when the torque decreases.

In other words, scrolling at a low differential speed retains the solids inside the centrifuge longer so that more liquid is removed from the slurry for a drier solids output. The problem with this is that the system is just running on the edge of overloading the gear reducer 34. In the second embodiment of the invention, the system monitors the scroll torque and this is set close to the maximum. When torque approaches its set point, then the system slowly increases differential speed to reduce torque.

Referring now to FIG. 2, a more detailed schematic of the invention is depicted, wherein like components are designated with like numerals. The system shown in FIG. 2 includes the manual differential speed control 70 which further includes a lower differential speed valve 72 and a raise differential speed valve 74. The valves 72 and 74 are coupled to the servo control 66 to alter the set position of the slant plate in the pump/motor 44 and therefore its selected stroke. The selected stroke determines the initial set volume output of the pump/motor 44 and therefore the speed of the backdrive motor 40. If the influent into the centrifuge increases, the conveyor torque will increase, which is sensed by a valve 76 which interrupts the signal to the pump swash plate and pump flow decreases, causing the motor 40 to slow down, causing the conveyor to speed up.

It should be noted that the backdrive motor and the pump/motor are shown in FIGS. 1 and 2 external to the bearing. However, the backdrive motor 40 may be situated within the screw conveyor in order to minimize the force outside the bearing 32. This alters the system from a high speed, low torque system to a low speed, high torque system by eliminated the need for the gear reducer 34. The present invention also permits retrofit of many centrifuges in the field with the back drive disclosed.

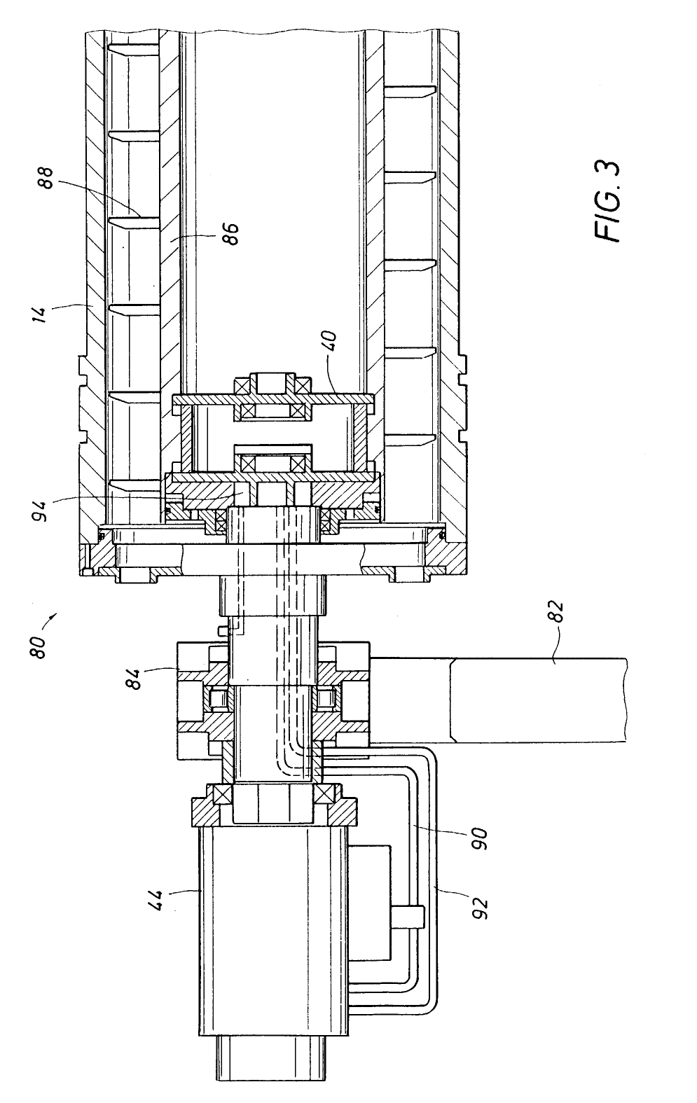

The view of FIG. 3 is greatly simplified for clarity in order to focus on the salient features of this embodiment of the present invention. This embodiment comprises a backdrive control system 80 mounted to a support pedestal 82 and supported by a bearing member 84. The control system 80 includes the backdrive motor 40, as previously described, but in this case mounted within a shaft 86 of the scroll conveyor which retains the screw shaped flite 88 to move separated solids through the centrifuge. The flite 88 moves in close proximity to the bowl 14 at a differential speed, as driven by the backdrive motor 40. On the opposite side of the bearing member 84 is mounted the pump/motor 44, also as previously described. A pair of hydraulic lines 90 and 92 delivers hydraulic fluid under pressure to a rotary hydraulic coupling 94 to power the backdrive motor 40.

Note that this embodiment eliminates much of the weight which was cantilevered to the left (as seen in FIG. 3) of the pump/motor 44. Further, this embodiment eliminates the need for the gear box or gear reducer 34, as in FIGS. 1 and 2. In this embodiment, the backdrive motor 40 is mounted to the shaft 86, which turns at a speed differential from the bowl 14, and thus provides a low speed, high torque operation.

In operation, a number of limiting criteria must be met simultaneously, including feed rate of the slurry and its solids/liquids content, which can vary, and the maximum permissible liquids content of the solids which are discharged from the centrifuge. By experience in testing the effectiveness of the invention, we have found that the present invention operates most effectively if the operating controls set the speed of operation at the maximum torque permitted by the backdrive motor, and operate the centrifuge full out. Then, as solids content of the influent slurry varies, the hydrostatic backdrive of the invention adjusts accordingly, maintaining less than the maximum permitted liquids on the solids discharge.

The principles, preferred embodiment, and mode of operation of the present invention have been described in the foregoing specification. This invention is not to be construed as limited to the particular forms disclosed, since these are regarded as illustrative rather than restrictive. Moreover, variations and changes maybe made by those skilled in the art without departing from the spirit of the invention.

We claim:

1. A system for controlling the differential speed of a centrifuge having a bowl and a screw conveyor therein, the system comprising:
a. a pump commonly driven with the bowl;
b. a conveyor drive motor driven by the pump, and coupled to the screw conveyor; and
c. a selector on the pump to control the operation of the pump/motor to drive the conveyor drive motor at a constant selected differential speed.

2. The system of claim 1, further comprising a gear reducer driven by the bowl to couple the bowl to the pump.

3. The system of claim 1, wherein the selector is a manual control to permit an operator to selectively raise or lower the selected differential speed.

4. The system of claim 1, wherein the selector includes a predetermined minimum selectable differential speed.

5. The system of claim 1, wherein the bowl and screw conveyor are driven by a common prime mover.

6. A method of controlling the differential speed of a centrifuge having a bowl and a screw conveyor, the method comprising the steps of:
a. selecting a predetermined relative speed between the bowl and the screw conveyor;
b. coupling a back drive motor to the screw conveyor to drive the screw conveyor at that predetermined speed; and
c. driving a pump/motor by the bowl to supply hydraulic drive fluid to the back drive motor at a rate to maintain the predetermined relative speed.

7. The method of claim 6, further comprising the step of manual selecting the predetermined relative speed on a speed controller on the pump/motor.

8. A system for controlling the torque on a screw conveyor of a centrifuge having a bowl and the screw conveyor therein, the system comprising:
a. a pump/motor commonly driven with the bowl;
b. a back drive motor driven by the pump/motor, and coupled to the screw conveyor; and
c. a selector on the pump/motor to control the operation of the pump/motor to drive the back drive motor at a constant selected torque on the screw conveyor.

9. The system of claim 8, further comprising a gear reducer coupling the bowl to the pump/motor.

10. The system of claim 9, wherein the pump/motor is coupled to the gear reducer with a belt drive.

11. The system of claim 8, wherein the bowl and screw conveyor are enclosed within an enclosure.

12. The system of claim 11, wherein the backdrive motor is located within the bowl.
